(19) United States
(12) Patent Application Publication
(10) Pub. No.: US 2020/0152074 A1
(43) Pub. Date: May 14, 2020

(54) Educational Doll Assembly

(71) Applicant: Dermot P. Henley, Naples, FL (US)

(72) Inventor: Dermot P. Henley, Naples, FL (US)

(21) Appl. No.: 16/185,070

(22) Filed: Nov. 9, 2018

(51) Int. Cl. G09B 5/06; H04R 1/02; A63H 3/00; A63H 3/28

(52) U.S. Cl. CPC G09B 5/062; H04R 1/028; A63H 2200/00; A63H 3/28; A63H 3/006

(57) ABSTRACT

An educational doll assembly includes a doll that a head, a control circuit that is coupled to the doll and an electronic memory that is coupled to the doll. The electronic memory stores a database comprising audible pronunciations of letters of the alphabet. A plurality of buttons is each movably coupled to the doll and each of the buttons is positioned on the head. The control circuit receives an alert input when any of the buttons is manipulated. Each of the buttons has indicia is printed thereon and the indicia comprise a plurality of lower case letters each is assigned to a respective one of the buttons. A speaker is coupled to the doll to emit audible sound outwardly therefrom and the speaker is electrically coupled to the control circuit. The speaker emits the audible pronunciation of the letter of the alphabet corresponding to the manipulated button. In this way the speaker assists the user with learning lower case letters of the alphabet.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to educational devices and more particularly pertains to a new educational device for teaching the difference between upper and lower case letters of the alphabet.

### BRIEF SUMMARY OF THE INVENTION

An embodiment of the disclosure meets the needs presented above by generally comprising a doll that a head, a control circuit that is coupled to the doll and an electronic memory that is coupled to the doll. The electronic memory stores a database comprising audible pronunciations of letters of the alphabet. A plurality of buttons is each movably coupled to the doll and each of the buttons is positioned on the head. The control circuit receives an alert input when any of the buttons is manipulated. Each of the buttons has indicia is printed thereon and the indicia comprise a plurality of lower case letters each is assigned to a respective one of the buttons. A speaker is coupled to the doll to emit audible sound outwardly therefrom and the speaker is electrically coupled to the control circuit. The speaker emits the audible pronunciation of the letter of the alphabet corresponding to the manipulated button. In this way the speaker assists the user with learning lower case letters of the alphabet.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an educational doll assembly according to an embodiment of the disclosure.

FIG. 2 is a left side view of an embodiment of the disclosure.

FIG. 3 is a front view of a switch of an embodiment of the disclosure.

FIG. 4 is a front view of a head of a doll of an embodiment of the disclosure.

FIG. 5 is a front phantom of an embodiment of the disclosure.

### DETAILED DESCRIPTION OF THE INVENTION

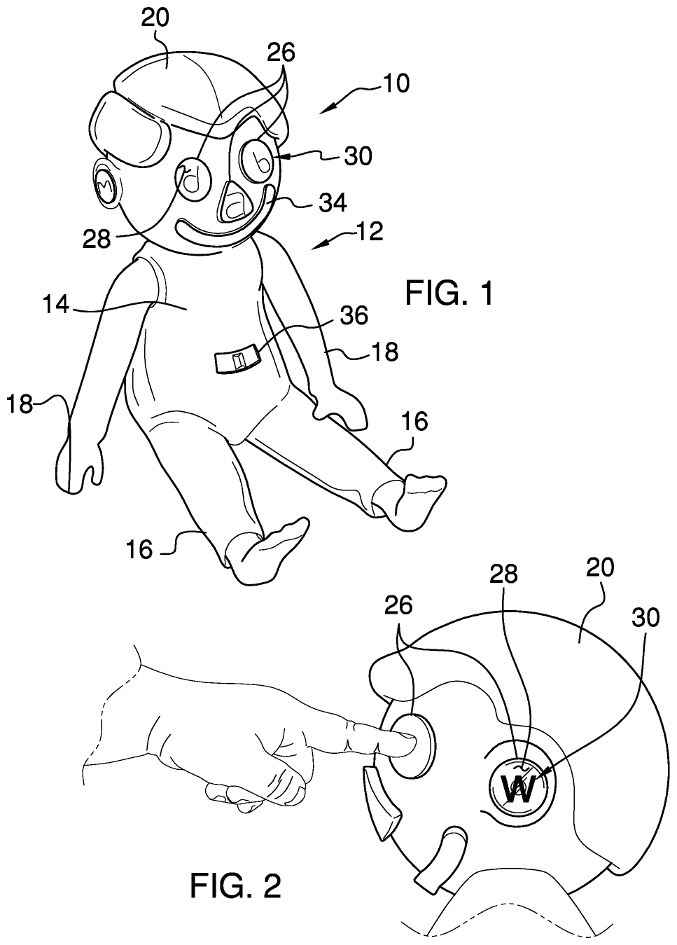

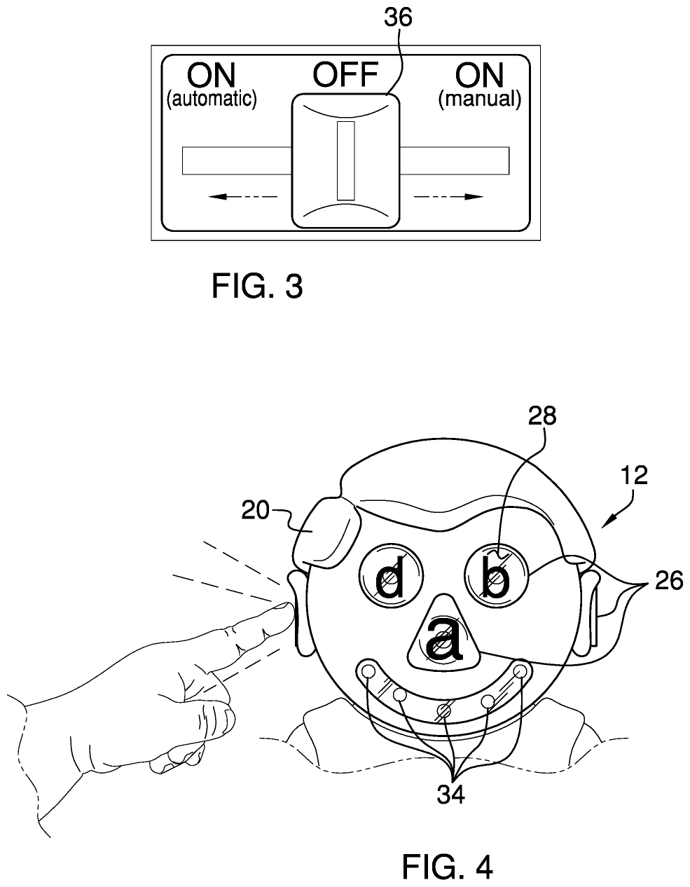

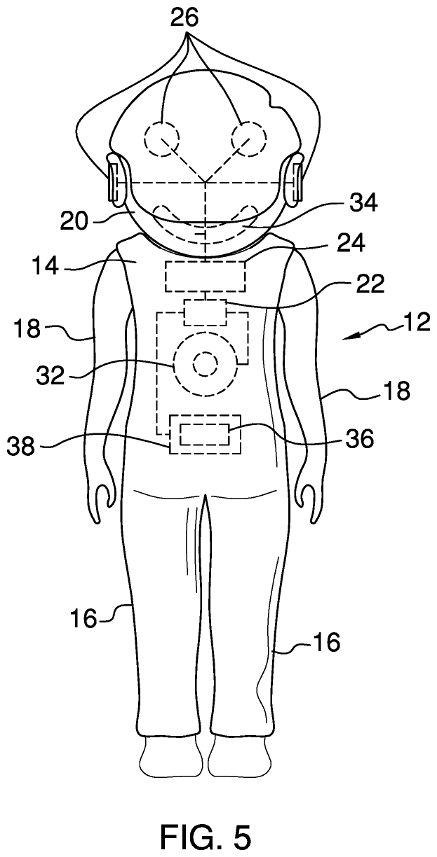

With reference now to the drawings, and in particular to FIGS. 1 through 5 thereof, a new educational device embodying the principles and concepts of an embodiment of the disclosure and generally designated by the reference numeral 10 will be described.

As best illustrated in FIGS. 1 through 5, the educational doll assembly 10 generally comprises a doll 12 that has a body 14, a pair of legs 16, a pair of arms 18 and a head 20. Additionally, the doll 12 may be structured to resemble a human female or a human male. A control circuit 22 is coupled to the doll 12 and an electronic memory 24 is coupled to the doll 12. The electronic memory 24 is electrically coupled to the control circuit 22 and the electronic memory 24 stores a database comprising audible pronunciations of letters of the alphabet.

A plurality of buttons 26 is each movably coupled to the doll 12 and each of the buttons 26 is positioned on the head 20. Moreover, each of buttons 26 is strategically positioned on the head 20 to resemble eyes, ears and a nose of the doll 12. Each of the buttons 26 is electrically coupled to the control circuit 22 and the control circuit 22 receives an alert input when any of the buttons 26 is manipulated. Each of the buttons 26 has an outwardly facing surface 28 and the outwardly facing surface 28 of each of the buttons 26 has indicia 30 printed thereon. The indicia 30 comprises a plurality of lower case letters that is each assigned to a respective one of the buttons 26. Moreover, the indicia 30 may include the lower case letters “d” “b” m″ “w” “a” and “c”

A speaker 32 is coupled to the doll 12 to emit audible sound outwardly therefrom and the speaker 32 is electrically coupled to the control circuit 22. The electronic memory 24 communicates the audible pronunciation of the letter of the alphabet corresponding to a manipulated button to the speaker 32 when the control circuit 22 receives the alert input. Thus, the speaker 32 emits the audible pronunciation of the letter of the alphabet corresponding to the manipulated button. In this way the speaker 32 assists a user, such as a child or other user who is learning to read and write, with learning lower case letters of the alphabet.

A plurality of light emitters 34 is each coupled to the head 20 and each of the light emitters 34 is electrically coupled to the control circuit 22. Each of the light emitters 34 is turned on when the control circuit 22 receives the alert input, and the plurality of light emitters 34 is arranged to form a smile on the head 20. Each of the light emitters 34 may comprise an LED or the like and each of the light emitters 34 facilitates a visual alert in conjunction with the audible pronunciation emitted by the speaker 32.

A switch 36 is slidably coupled to the doll 12 and the switch 36 is electrically coupled to the control circuit 22. The switch 36 has an off position, a manual position and an automatic position. A power supply 38 is coupled to the doll 12, the power supply 38 is electrically coupled to the control circuit 22 and the power supply 38 comprises at least one battery.

In use, the switch 36 is positioned in the either the manual position or the automatic position. The control circuit 22 randomly selects audible pronunciations from the electronic memory 24 to be emitted from the speaker 32 when the switch 36 is in the automatic position. Thus, the user is instructed to depress the button that corresponds to the emitted audible pronunciation when the switch 36 is positioned in the automatic position. In this way the doll 12 assists the user with associating printed letters of the alphabet with the pronunciation of the letters of the alphabet. The speaker 32 emits the audible pronunciation from the electronic memory 24 that corresponds to a manipulated button when the switch 36 is in the manual position. Thus, the user can hear the audible pronunciation of the letter on the manipulated button.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An educational doll assembly being configured to teach upper and lower case letters of the alphabet, said assembly comprising:
a doll having a body, a pair of legs, a pair of arms and a head;
a control circuit being coupled to said doll;
an electronic memory being coupled to said doll, said electronic memory being electrically coupled to said control circuit, said electronic memory storing a database comprising audible pronunciations of letters of the alphabet;
a plurality of buttons, each of said buttons being movably coupled to said doll, each of said buttons being positioned on said head, each of buttons being strategically positioned on said head to resemble eyes, ears and a nose of said doll, each of said buttons being electrically coupled to said control circuit, said control circuit receiving an alert input when any of said buttons is manipulated, each of said buttons having indicia being printed thereon, said indicia comprising a plurality of lower case letters each being assigned to a respective one of said buttons; and
a speaker being coupled to said doll wherein said speaker is configured to emit audible sound outwardly therefrom, said speaker being electrically coupled to said control circuit, said electronic memory communicating the audible pronunciation of the letter of the alphabet corresponding to a manipulated button to said speaker when said control circuit receives said alert input, said speaker emitting the audible pronunciation of the letter of the alphabet corresponding to the manipulated button wherein said speaker is configured to assist the user with learning lower case letters of the alphabet.

2. The assembly according to claim 1, further comprising a plurality of light emitters, each of said light emitters being coupled to said head, each of said light emitters being electrically coupled to said control circuit, each of said light emitters being turned on when said control circuit receives said alert input, said plurality of light emitters being arranged to form a smile on said head.

3. The assembly according to claim 1, further comprising a switch being slidably coupled to said doll, said switch being electrically coupled to said control circuit, said switch having an off position, a manual position and an automatic position.

4. The assembly according to claim 3, wherein said control circuit randomly selects audible pronunciations from said electronic memory to be emitting from said speaker thereby urging the user to depress said button that corresponds to the emitted audible pronunciation when said switch is positioned in said automatic position.

5. The assembly according to claim 4, wherein said speaker emits the audible pronunciation from said electronic memory that corresponds to a manipulated button when said switch is in said manual position.

6. The assembly according to claim 1, further comprising a power supply being coupled to said doll, said power supply being electrically coupled to said control circuit, said power supply comprising at least one battery.

7. An educational doll assembly being configured to teach upper and lower case letters of the alphabet, said assembly comprising:
a doll having a body, a pair of legs, a pair of arms and a head;
a control circuit being coupled to said doll;
an electronic memory being coupled to said doll, said electronic memory being electrically coupled to said control circuit, said electronic memory storing a database comprising audible pronunciations of letters of the alphabet;
a plurality of buttons, each of said buttons being movably coupled to said doll, each of said buttons being positioned on said head, each of buttons being strategically positioned on said head to resemble eyes, ears and a nose of said doll, each of said buttons being electrically coupled to said control circuit, said control circuit receiving an alert input when any of said buttons is manipulated, each of said buttons having an outwardly facing surface, said outwardly facing surface of each of said buttons having indicia being printed thereon, said indicia comprising a plurality of lower case letters each being assigned to a respective one of said buttons;
a speaker being coupled to said doll wherein said speaker is configured to emit audible sound outwardly therefrom, said speaker being electrically coupled to said control circuit, said electronic memory communicating the audible pronunciation of the letter of the alphabet corresponding to a manipulated button to said speaker when said control circuit receives said alert input, said speaker emitting the audible pronunciation of the letter of the alphabet corresponding to the manipulated button wherein said speaker is configured to assist the user with learning lower case letters of the alphabet;
a plurality of light emitters, each of said light emitters being coupled to said head, each of said light emitters being electrically coupled to said control circuit, each of said light emitters being turned on when said control circuit receives said alert input, said plurality of light emitters being arranged to form a smile on said head;
a switch being slidably coupled to said doll, said switch being electrically coupled to said control circuit, said switch having an off position, a manual position and an automatic position, said control circuit randomly selecting audible pronunciations from said electronic memory to be emitting from said speaker thereby urging the user to depress said button that corresponds to the emitted audible pronunciation when said switch is positioned in said automatic position, said speaker emitting the audible pronunciation from said electronic memory that corresponds to a manipulated button when said switch is in said manual position; and
a power supply being coupled to said doll, said power supply being electrically coupled to said control circuit, said power supply comprising at least one battery.
